(19) United States
(12) Patent Application Publication
(10) Pub. No.: US 2006/0211561 A1
(43) Pub. Date: Sep. 21, 2006

(54) Silicon alloys materials as silver migration inhibitors

(76) Inventors: Joel D. Houmes, Hamilton, OH (US); Hasan B. Emlemdi, Hamilton, OH (US)

Correspondence Address: FROST BROWN TODD, LLC, 2200 PNC CENTER, 201 E. FIFTH STREET, CINCINNATI, OH, 45202, US

(21) Appl. No.: 11/377,099

(22) Filed: Mar. 16, 2006

Related U.S. Application Data
(60) Provisional application No. 60/663,780, filed on Mar. 21, 2005.

(51) Int. Cl. C03C 8/18; C03C 17/00

(52) U.S. Cl. 501/19; 65/60.53

(57) ABSTRACT

An enamel composition providing improved silver bus bar hiding for automotive applications is disclosed. The enamel consists of a carrier vehicle, and a solid portion which includes one or more glass frits and a metal silicide where the metal consists of one or more elements from groups IA, IIA, IIIB, IVB, VB, VIB, VIIB, VIII, IB, IIB, IIIA, IVA, VA, VIA, VIIA, VIIIA, and/or a lanthanide and/or actinide of the periodic table. The metal silicide comprises from about 0.01 to about 20 percent of the solid portion.

### CROSS-REFERENCE TO RELATED APPLICATION

This application is related to and claims priority from U.S. Provisional Patent Application No. 60/663,780, Houmes and Emlemdi, filed Mar. 21, 2005, incorporated herein by reference.

### TECHNICAL FIELD

This patent application relates to the fields of colored enamels used for the coloring of glass and, particularly, for glass panes subsequently provided with silver conducting tracks or leads. The enamel exhibits an improved opacity for silver layers and comprises glass frit, one or more pigments in the form of heavy-metal oxides or sulfides, and one or more metal suicides.

### BACKGROUND OF THE INVENTION

For many years, as discussed in Andrews, U.S. Pat. No. 4,837,383, issued Jun. 6, 1989, the automobile industry has manufactured automobiles with back windows which include electrical heating elements to remove frost formed on the window surface. The electrical heating elements are printed by a silkscreen printing process with a grid of a metallic material which is then fired on the glass window. The grid material from which the heating element is formed typically comprises a mixture containing a silver powder and a small amount of soft glass dispersed in a printing vehicle, such as oil, suitable for silkscreen printing. In most instances, the grid arrangement forming the heating elements is comprised of a bus bar extending along each side of the window, and a series of fine lines extending horizontally across the window, with the fine lines being connected to the bus bar. In other instances, the same techniques are used for the application of conductive circuits and radio antennas onto the glass window.

Also frequently applied to the window is a dark gray or black enamel border extending around the periphery, or outer edge, of the back window. The border is printed for aesthetic reasons in order to hide the underlying adhesive layer, which attaches the window to the automobile body, from exterior view. Also, the enamel border protects the adhesive from degradation due to exposure to ultraviolet light.

In some instances, the bus bars are printed over the enamel border but, after firing, the bus bars are still visible, and appear from the outside of the automobile, for example, as a dark amber color. It is known that silver compounds which are applied onto glass or enamel impart a yellowish to brown coloration. In the case of automotive bus bar applications, it is believed that the amber color results from the migration of cationic silver ions through the enamel layer to the glass substrate.

In order to prevent the detection of the bus bars from the outside of the automobile, some prior art patents disclose altering the composition of the enamel utilized to form the border. In particular, some prior art patents disclose the addition of a reducing agent such as powdered zinc, tin, cadmium, or manganese to the enamel to reduce the silver ions and inhibit silver migration. Some prior art patents also suggest the addition of powdered metals such as zinc, tin, cadmium or manganese to the enamel, paint or die to facilitate the forming of the glass substrate by helping to prevent the sticking of the forming head or die to the paint or enamel. Further prior art patents also suggest separate and distinct addition of semimetallic silicon to the enamel, which can also help to prevent sticking of the forming head or die to the paint or enamel.

More particularly, disclosed in U.S. Pat. Nos. 4,684,388, Boaz, issued Aug. 4, 1987, and U.S. Pat. No. 4,684,389, Boaz, issued Aug. 4, 1987, are means to form a glass sheet having an oil base paint fired thereupon wherein the paint contains a fine zinc metal powder. U.S. Pat. No. 4,684,388 further discloses the inclusion of a fine stannous oxide powder in an ultraviolet curable paint which, when applied to the glass sheet, is subject to ultraviolet radiation and heated to a temperature to soften the glass sheet to allow bending thereof. The paint on the glass engages with a fiberglass covering on a forming head or die. U.S. Pat. No. 4,684,389 discloses an oil base paint to which fine zinc powder is added to the paint applied to the glass sheet. The painted glass sheet is then heated to a forming temperature and engaged with a fiberglass covering of a die to form a glass sheet of a desired shape. The metal powder functions to prevent the sticking of the paint to the fiberglass of the forming head or die during the forming process.

Boaz, U.S. Pat. No. 4,596,590, issued Jun. 24, 1986, discloses a method of forming a glass sheet with a paint that minimizes sticking. The paint includes a metal oxide powder having at least a low valence oxidation state and a high valence oxidation state, the metal oxide powder being in its low valence state when applied. Examples of suitable metal oxide powders include stannous oxide, iron oxide and cuprous oxide.

Stotka, U.S. Pat. No. 4,983,196, issued Jan. 8, 1991, also discloses an enamel composition that minimizes sticking. The enamel includes an iron metal powder to help prevent adhesion during the forming operation.

Andrews, et al., U.S. Pat. No. 4,975,301, issued Dec. 4, 1990, discloses a glass enamel which serves to help hide the bus bars of the heating element. The enamel disclosed by Andrews, et al. comprises powdered zinc, tin, cadmium, manganese, iron, and mixtures and alloys thereof for use in conjunction with a soda-free flux glass. Andrews, U.S. Pat. No. 4,837,383, issued Jun. 6, 1989, also discloses a glass enamel which serves to help hide the bus bars of the heating elements. The enamel disclosed by Andrews includes aluminum or lithium oxide.

Korn, et al., U.S. Pat. No. 5,334,412, issued Aug. 2, 1994, discloses a glass enamel coating with an improved opacity relative to the silver conducting tracks. The enamel includes a separate and distinct addition of silicon. In addition, the enamel disclosed by Korn, et al, facilitates the forming of the glass substrate by helping to prevent the sticking of the forming head or die to the paint or enamel.

Chaumonot, et al., U.S. Pat. No. 5,141,798, issued Aug. 25, 1992, discloses a glass enamel coating with an improved opacity relative to the silver conducting tracks. The improved opacity is obtained by the addition of silicon, boron, carbon, lead and/or silver in elemental form to the enamel.

Anquetil, U.S. Pat. No. 5,350,718, issued Sep. 27, 2994, discloses a glass enamel that can be used as a barrier layer for stopping the migration of silver. The enamel disclosed by Anquetil includes sulfur, zinc sulfide or other sulfides.

### SUMMARY OF THE INVENTION

The present invention relates to the synthesis and application of a glass enamel comprising a vehicle and a solids portion. The present invention provides a new and improved glass enamel composition which provides many advantages over prior art enamel compositions. In particular, the present invention is very effective in hiding the bus bars of the heating element of an automotive back window.

The solids portion of the composition may include pigments and fillers. The solids portion includes at least one glass frit and a metal silicide where the metal consists of one or more elements from groups IA, IIA, IIIB, IVB, VB, VIB, VIIB, VIII, IB, IIB, IIIA, IVA, VA, VIA, VIIA, VIIIA, or a lanthanide or actinide of the periodic table. The solids portion comprises from about 0.01 weight percent to about 20 weight percent of the metal silicide. Preferably, the solids portion comprises from about 0.02 weight percent to about 15 weight percent of the metal silicide. More preferably, the solids portion comprises from about 0.04 weight percent to about 10 weight percent metal silicide. Suitable frits for use in connection with the invention include, for example, lead borosilicate frits, zinc borosilicate frits, bismuth borosilicate frits, and other lead-containing or lead-free frits whose properties make them useful for the present application, as well as mixtures of those materials.

The invention further provides a method of decorating a glass substrate. The method includes the steps of applying to the glass substrate an enamel composition, as defined above, comprising a vehicle and a solids portion; drying or curing the applied enamel composition; and firing the glass substrate bearing the enamel composition. The solids portion of the enamel composition includes a metal silicide.

The invention is also applicable to the production of thin and thick film electronic components and provides for a method to minimize the inter- and intra-diffusion of metallic atoms within the electrodes and from the electrodes to the substrate. Such components include, for example, bonding pads, piezoresistors, ceramic resistors, dielectric junctions, capacitors, CRT components, dielectric heaters, and other such components generated from application of a metallic conductive layer to a nonconducting or semiconducting ceramic or glass substrate. These components are subsequently fired at an elevated temperature. Such devices are typically produced by tape casting or screen printing of a paste consisting of a carrier vehicle, a finely ground glass frit, and conductive Ag flakes onto the substrates.

### DETAILED DESCRIPTION OF THE INVENTION

An enamel composition made in accordance with the principles of the present invention, for use in producing a layer of enamel or an enamel finish, band or border upon a section of glass, comprises a vehicle and a solids portion. The solids portion comprises at least one glass frit and a metal silicide where the metal consists of one or more elements from groups IA, IIA, IIIB, IVB, VB, VIB, VIIB, VIII, IB, IIB, IIIA, IVA, VA, VIA, VIIA, VIIIA, or a lanthanide or actinide of the periodic table. This addition of the metal silicide is in the metallic nonoxidized state, not in the oxide form as would be the case in a metal silicate.

The solids portion comprises from about 0.01 weight percent to about 20 weight percent of the metal silicide. Preferably, the solids portion comprises from about 0.02 weight percent to about 15 weight percent of the metal silicide. More preferably, the solids portion comprises from about 0.04 weight percent to about 10 weight percent metal silicide. The solids portion also includes glass frit generally selected from lead-free or lead-containing glass frit. Preferred frit materials include zinc borosilicate glass frit, a lead borosilicate glass frit, a bismuth borosilicate glass frit or other types of commercially available frits. The frit is generally present at from about 60% to about 90% of the solids portion. The solids portion may also include pigment.

The purity of the metal silicide is not critical, but is preferably at least about 97 percent by weight pure. Also, the particle size of the silicon is not critical, but finer particle sizes are more preferable. Applicants believe the practical upper limit on the amount of metal silicide additive depends on the characteristics of the enamel to which it is added and on the requirements of the application. For example, excessive amounts of metal silicide may increase the firing temperature of the resulting system beyond what is appropriate in a given plant or may impart a coloration that is undesirable for a given application (although it may be perfectly acceptable in a different plant or for a different application). The determination of this practical upper limit is well within the abilities of one of ordinary skill in the art.

The vehicle or carrier which is included in the enamel composition must be one which allows the enamel composition to take the form appropriate for application of the enamel composition to a section of glass such as, for example, a slurry, a paste or a thermoplastic pellet. An organic printing vehicle (i.e., a vehicle comprising organic solvents and suitable for printing the enamel on the glass substrate) is preferred.

The vehicle or carrier preferably comprises a solvent and a resin. Optionally, the vehicle or carrier may also comprise a thixotropic agent, wetting agents and/or other ingredients to effect the application or printing, drying, curing and/or burnout characteristics of the enamel.

Examples of suitable resins include ethyl cellulose; ethyl hydroxyl ethyl cellulose; wood resin; mixtures of ethyl cellulose and phenolic resins, polymethacrylates or lower alcohols; and monobutyl ether of ethylene glycol monoacetate.

Examples of suitable solvents include terpenes such as alpha- or beta-terpineol or mixtures thereof, kerosene, dibutyl phthalate, butyl carbitol, butyl carbitol acetate, hexylene glycol, high-boiling alcohols and alcohol esters. Various combinations of these and other solvents may be formulated to obtain the desired viscosity and volatility requirements for each application.

Examples of suitable thixotropic agents include organic-based thixotropics such as, for example, hydrogenated castor oil and derivatives thereof, and ethyl cellulose.

Examples of suitable wetting agents include fatty acid esters, for example, N-tallow-1,3-diaminopropane dioleate, N-tallow trimethylene diamine diacetate, N-coco trimethylene diamine, beta-diamines, N-oleyl trimethylene diamine, N-tallow trimethylene diamine, and/or N-tallow trimethylene diamine dioleate.

The enamel composition may also include one or more pigments and may include one or more fillers. Pigments will generally be present in the form of metal oxides or metal sulfides. Examples of potential suitable pigments include copper chromite black sold under the trade designation BK1G, cobalt aluminate blue sold under the trade designation BK385, and zinc iron chromite brown sold under the trade designation BR12, all sold by The Shepherd Color Company of Cincinnati, Ohio. A large number of coloring agents of widely varying composition are known to those skilled in the art. The pigment generally accounts for from about 1 percent by weight to about 30 percent by weight of the solids portion of the enamel composition.

Examples of fillers include alumina (Al₂O₃) and silicon dioxide (SiO₂). Fillers generally comprise less than about 10 percent, and preferably less than about 5 percent by weight of the solids portion of the enamel composition.

The invention further provides a method of decorating a glass substrate to, for example, serve as an electrically heated window that has a conductive metal coating applied thereto as an electrically resistive heating element. The method includes the steps of applying an enamel composition comprising a vehicle and a solids portion, the solids portion comprising a metal silicide; drying or curing the enamel composition which step is generally only done if the section of glass is to be stored prior to firing; applying the conductive metal coating, drying or curing the applied conductive metal coating; and firing the glass substrate. The glass substrate is fired at a temperature of from about 950 degrees F. (510 degrees C.) to about 1400 degrees F. (760 degrees C.). Preferably, the glass substrate is fired at a temperature of from about 1050 degrees F. (566 degrees C.) to about 1300 degrees F. (705 degrees C.). More preferably, the glass substrate is fired at a temperature of from about 1200 degrees F. (650 degrees C.) to about 1275 degrees F. (691 degrees C.). Once the glass substrate has been heated to temperature, it may be subjected to a forming operation.

The enamel composition is typically applied by silk-screening the enamel composition onto the glass substrate and drying the glass enamel composition in an oven to set the enamel and remove all or a portion of the solvent from the vehicle. Then the conductive coating composition is applied by the silk-screen process or other suitable application technique upon the glass substrate abutting or overlapping the dried glass enamel composition. The conductive coating composition may or may not be dried prior to firing. The substrate is then passed through a furnace to fire both coatings to cause them to melt, mature and adhere to the substrate. The glass substrate will typically pass through the furnace in a matter of several minutes (e.g., about 3 to 5 minutes) and at a temperature of from about 950 degrees F. (510 degrees C.) to about 1400 degrees F. (760 degrees C.).

Once the glass substrate has been heated to temperature it may be subjected to a forming operation. Such forming operation may be gravity forming or alternatively a press forming apparatus or device may be employed. The press head of the forming device may include a head covered with a refractory fiber material such as FIBERFAX® refractory fiber. FIBERFAX® is a registered trademark for refractory fiber owned by the Stemcot Corporation of Cleveland, Ohio.

The following example serves to further illustrate the novel features and advantages of the present invention. While this example will show one skilled in the art how to operate within the scope of this invention, it is not intended to serve as a limitation on the scope of the invention.

### EXAMPLE

Enamel compositions A, B and C are prepared by combining together in a conventional manner the following components. All percentages shown below are in parts by weight.

| Component | Enamel A | Enamel B | Enamel C (present invention) |
|---|---|---|---|
| Flux602¹ | 64% | 63% | 63% |
| BK1G² | 16% | 16% | 16% |
| Elemental Si³ | | 1% | |
| B₆Si⁴ | | | 1% |
| C-474⁵ | 20% | 20% | 20% |

¹Bismuth borosilicate frit available from Glass Coating and Concepts of Monroe, OH, under the trade designation Flux602.
²Copper chromite pigment available from The Shepherd Color Company of Cincinnati, OH, under the trade designation BK1G.
³10 micron silicon available from Elkem of Oslo, Norway, under the trade name jetmilled Silgrain.
⁴200 mesh, 98% B₆Si available from Cerac Specialty Inorganics of Milwaukee, WI, under the trade designation B-1089.
⁵Screen printing vehicle available from Glass Coatings and Concepts of Monroe, OH, under the trade designation C-474.

Once mixed, the enamels are then applied to glass slides and dried in an oven at about 250 degrees F. (121 degrees C.) for 5 minutes so as to substantially remove the vehicle. A stripe of silver paste, used to create a bus bar, is then applied over each of the enamels using a 140 mesh screen. Each of the glass slides is then fired at about 1200 degrees F. (650 degrees C.) for about 7 minutes. Upon cooling, the slides are examined in room light by viewing through the glass of the slide. The silver bus bar does not show through the underlying fired enamel and is not visible in room light through enamel C (the present invention). However, the simulated bus bar is clearly visible in room light through enamels A and B, though slightly less so for enamel B. Enamel C exhibits improved optical density over either enamel A or B.

What is claimed is:

1. An enamel for glass panes provided with silver conducting tracks which comprises a solids portion comprising from about 60 to about 90% by weight glass frit; and from about 1 to about 30% by weight of one or more pigments selected from metal oxides and metal sulfides; and from about 0.01 to about 20% by weight of a metal silicide.

2. An enamel according to claim 1 wherein the metal silicide is an alloy of silicon and one or more elements from groups IA, IIA, IIIB, IVB, VB, VIB, VIIB, VIII, IB, IIB, IIIA, IVA, VA, VIA, VIIA, VIIIA, or a lanthanide or actinide of the periodic table.

3. An enamel according to claim 2 wherein said glass frit is selected from the group consisting of: (i) zinc borosilicate glass frit; (ii) lead borosilicate glass frit; (iii) bismuth borosilicate glass frit; (iv) lead-containing glass frit; (v) lead-free glass frit; and (vi) mixtures thereof

4. An enamel according to claim 3 wherein the glass frit is selected from bismuth borosilicate glass frit, zinc borosilicate glass frit, lead borosilicate glass frit, and mixtures thereof.

5. An enamel according to claim 1 which additionally comprises a vehicle.

6. An enamel according to claim 5 wherein the vehicle is an organic printing vehicle.

7. A method of decorating a glass substrate to serve as an electrically heated window, said electrically heated window having a conductive metal coating applied thereto which serves as an electrically resistive heating element, said method comprising the steps of:
A. applying to said glass substrate an enamel composition comprising a vehicle and a solids portion, said solids portion comprising a glass frit and a metal silicide where the metal consists of one or more elements from groups IA, IIA, IIIB, IVB, VB, VIB, VIIB, VIII, IB, IIB, IIA, IVA, VA, VIA, VIIA, VIIIA, or a lanthanide or actinide of the periodic table, said solids portion comprising from about 0.01 weight percent to about 20 weight percent of said metal silicide;
B. optionally, drying or curing said applied enamel composition;
C. applying the conductive metal coating over said enamel composition;
D. optionally, drying or curing said applied conductive metal coating; and
E. firing said glass substrate bearing said conductive metal coating and said enamel composition.

8. A method according to claim 7 wherein, during step E, said glass substrate is fired at a temperature from about 950 degrees F. to about 1400 degrees F.

9. A method according to claim 7 including the additional step of:
F. forming said glass substrate bearing said conductive metal coating and enamel composition.

10. A method according to claim 8 wherein, during step E, said glass substrate is fired at a temperature of from about 1050 degrees F. to about 1300 degrees F.

11. A method according to claim 10 wherein, during step E, said glass substrate is fired at a temperature of from about 1200 degrees F. to about 1275 degrees F.

12. A method according to claim 9 wherein, during step F, a press apparatus having a press head including a refractory fiber surface is employed to form said glass substrate.

13. A method according to claim 7 wherein, during step A, said enamel composition is applied to said glass substrate using a silk-screening technique.

14. A method according to claim 7 wherein said solids portion comprises from about 0.02 weight percent to about 15 weight percent of said metal silicide.

15. A method according to claim 14 wherein said solids portion comprises from about 0.04 weight percent to about 10 weight percent metal silicide.

16. A method according to claim 7 wherein said conductive metal coating comprises a silver paste.

17. A method according to claim 9 wherein, during step F, said glass substrate is formed by gravity forming.

18. A method according to claim 10 wherein said glass frit is selected from the group consisting of: (i) a zinc borosilicate glass frit; (ii) a lead borosilicate glass frit; (iii) a bismuth borosilicate glass frit; (iv) a lead containing glass frit; (v) a lead-free glass frit, and (vi) mixtures thereof.

19. A method according to claim 7 wherein said vehicle comprises an organic printing vehicle.

20. A method according to claim 7 wherein said solids portion includes a pigment.

21. A conductive paste comprising a conductive powder and glass frit dispersed in an organic vehicle, in which the conductive powder is present at from about 20 to 80 wt. % of the glass frit, and wherein the paste additionally comprises from about 0.01 to about 20% by weight of a metal silicide consisting of an alloy of silicon and one or more elements from groups IA, IIA, IIIB, IVB, VB, VIB, VIIB, VIII, IB, IIB, IIIA, IVA, VA, VIA, VIIA, VIIIA, or a lanthanide or actinide of the periodic table.

22. The conductive paste according to claim 21 wherein the conductive powder comprises, in whole or part, an Ag material or Ag containing alloy material.

23. A ceramic electronic component, comprising: a ceramic element assembly having a surface; and a terminal electrode contacting said ceramic element assembly surface, wherein said terminal electrode is a baked conductive paste according to claim 22.

24. A multi-layer ceramic electronic component according to claim 23, further comprising a plurality of internal electrodes composed of said conductive paste.

25. An electronic part comprising a plurality of ceramic components joined, connected, or otherwise attached by the conductive paste according to claim 21.
